(19) United States
(12) Patent Application Publication
(10) Pub. No.: US 2022/0141584 A1
(43) Pub. Date: May 5, 2022

(54) LATENT VARIABLE OPTIMIZATION APPARATUS, FILTER COEFFICIENT OPTIMIZATION APPARATUS, LATENT VARIABLE OPTIMIZATION METHOD, FILTER COEFFICIENT OPTIMIZATION METHOD, AND PROGRAM

(71) Applicant: NIPPON TELEGRAPH AND TELEPHONE CORPORATION, Tokyo (JP)

(72) Inventors: Ryotaro SATO, Tokyo (JP); Kenta NIWA, Tokyo (JP); Noboru HARADA, Tokyo (JP)

(73) Assignee: NIPPON TELEGRAPH AND TELEPHONE CORPORATION, Tokyo (JP)

(21) Appl. No.: 17/428,251

(22) PCT Filed: Jan. 23, 2020
(86) PCT No.: PCT/JP2020/002205

§ 371 Date: Aug. 3, 2021

(30) Foreign Application Priority Data
Feb. 5, 2019 (JP) 2019-018424

(51) Int. Cl. H04R 3/04; G06F 17/18; H04R 5/04

(52) U.S. Cl. CPC H04R 3/04; H04R 5/04; G06F 17/18

(57) ABSTRACT

There is provided a technique for optimizing a latent variable by using a cost function in which a plurality of probabilistic assumptions are reflected simultaneously. A latent variable optimization apparatus includes an optimization unit which optimizes a latent variable ^{˜}w*, vⱼ(1≤j≤J) is an auxiliary variable of the latent variable ^{˜}w* expressed as vⱼ=Dⱼ^{˜}w*+bⱼ by using a matrix Dⱼ and a vector bⱼ, a cost term of the auxiliary variable vⱼ is expressed by using a probability distribution of the auxiliary variable vⱼ which is log-concave, and the optimization unit optimizes the latent variable ^{˜}w* by solving a minimization problem of a cost function including the sum of the cost term of the auxiliary variable vⱼ.

### TECHNICAL FIELD

The present invention relates to a technique for optimizing a latent variable of a model serving as an optimization target such as a filter coefficient in target sound enhancement.

### BACKGROUND ART

As a signal processing method of enhancing only a sound coming from a specific direction and suppressing noises in the other directions, beam forming which uses a microphone array is widely known. This method is commercially practical in a conference call system, a communication system in a car, a smart speaker, or the like. Many of conventional methods related to beam forming have derived an optimum filter by solving a minimization problem of a cost function under some constraint. For example, an MVDR beam former described in NPL 1 is obtained by using power of an output signal as a cost function and minimizing the cost function under a constraint of a distortionless characteristic to a target sound source direction. In addition, a maximum-likelihood (ML) beam former is derived by using power of a noise included in an output signal as a cost function and minimizing the cost function. Further, in order to improve the performance of the beam former, an attempt to add an additional constraint or cost term to the cost function has been made.

### CITATION LIST

### Non Patent Literature

[NPL 1] J. Capon, “High-resolution frequency-wavenumber spectrum analysis”, Proceedings of the IEEE, vol. 57, no. 8, pp. 1408-1418, August 1969.

### SUMMARY OF THE INVENTION

### Technical Problem

It is considered that, when the beam former is applied to an actual situation, it is useful in terms of application to allow the beam former to have a plurality of characteristics simultaneously. For example, in some cases, the beam former capable of achieving a low delay characteristic while maintaining high enhancement performance to voice may be required. A request for the characteristic of the beam former can be modeled theoretically in the form of a probabilistic assumption on an auxiliary variable defined from a filter coefficient of the beam former. For example, when preliminary knowledge that a sound to be enhanced is human voice is provided, it is appropriate to assume that an estimated signal conforms to a distribution having high sparseness in a time-frequency domain such as the Laplace distribution. In addition, it is empirically known that it is natural that the filter coefficient changes continuously and smoothly in a frequency direction. However, the characteristic of the filter coefficient related to the frequency direction has not been reflected in the conventional method, and hence a situation in which a solution becomes unstable in a frequency bin in which a spatial correlation matrix is rank-deficient, and this characteristic is not satisfied has been observed. If it is possible to perform design in which smoothness is reflected, the effect of obtaining a filter having low delay is expected to be achieved. If the assumptions described above can be incorporated in the estimation of the filter coefficient simultaneously, the beam former having not only target sound enhancement but also various characteristics is expected to be configured.

However, conventionally, a study of a mathematical method related to optimization of the cost function has not been conducted adequately and, in particular, a study related to the optimization of the cost function in which a plurality of probabilistic assumptions are reflected simultaneously has not been conducted.

To cope with this, an object of the present invention is to provide a technique for optimizing a latent variable by using a cost function in which a plurality of probabilistic assumptions are reflected simultaneously.

### Means for Solving the Problem

An aspect of the present invention is a latent variable optimization apparatus including: an optimization unit which optimizes a latent variable ^{˜}w*, wherein vⱼ(1≤j≤J) is an auxiliary variable of the latent variable ^{˜}w* expressed as vⱼ=Dⱼ^{˜}w*+bⱼ by using a matrix Dⱼ and a vector bⱼ, a cost term of the auxiliary variable vⱼ is expressed by using a probability distribution of the auxiliary variable vⱼ which is log-concave, and the optimization unit optimizes the latent variable ^{˜}w* by solving a minimization problem of a cost function including the sum of the cost term of the auxiliary variable vⱼ.

### Effects of the Invention

According to the present invention, it becomes possible to optimize the latent variable by using the cost function in which a plurality of the probabilistic assumptions are reflected simultaneously.

### BRIEF DESCRIPTION OF DRAWINGS

FIG. 1 is a view showing a latent variable optimization algorithm.

FIG. 2 is a block diagram showing the configuration of a latent variable optimization apparatus 100 (filter coefficient optimization apparatus 100).

FIG. 3 is a flowchart showing the operation of the latent variable optimization apparatus 100 (filter coefficient optimization apparatus 100).

FIG. 4 is a block diagram showing the configuration of an optimization unit 120.

FIG. 5 is a flowchart showing the operation of the optimization unit 120.

### DESCRIPTION OF EMBODIMENTS

Hereinbelow, an embodiment of the present invention will be described in detail. Note that constituent parts having the same function are designated by the same reference numeral, and the duplicate description thereof will be omitted.

Prior to the description of each embodiment, a notation method in the description will be described.

_(underscore) denotes a subscript. In the case of, e.g., x^{y_z}, y_{z} is a superscript for x and, in the case of x_{y_z}, y_{z} is a subscript for x.

In addition, superscripts “\hat{ }” and “^{˜}” such as \hat{ }x and ^{˜}x for a given letter x are supposed to be written at positions immediately above “x” normally. However, due to limitations of the notation of the description, they are written as \hat{ }x and ^{˜}x.

### TECHNICAL BACKGROUND

In the embodiment of the present invention, a filter coefficient is optimized (learned) by using a cost function designed based on a probabilistic assumption on the filter coefficient or an auxiliary variable determined from the filter coefficient. Herein, the auxiliary variable is limited to that expressed as an affine transformation of the filter coefficient and, for example, an estimated target sound, noises included in an output signal, a difference in filter coefficient between adjacent frequency bins are included in this category. When all probability distributions assumed in the filter coefficient and its auxiliary variable are log-concave (logarithm-concave), a joint probability distribution when the filter coefficient and the auxiliary variable are considered to be independent of each other is also log-concave, and hence a negative logarithm likelihood is a convex function, and a cost function optimization problem results in the optimization problem of the convex function related to the auxiliary variable constrained by a linear relational expression. This optimization problem can be solved by using, e.g., the alternating direction method of multipliers (ADMM), and the optimum filter coefficient can be efficiently calculated.

Hereinbelow, principles of the embodiment of the present invention described above will be described in detail. First, the problem of beam forming is formulated from the viewpoint of optimization based on probability, and a description is given of the fact that the conventional beam forming optimization problem can be described in the framework of the formulation.

<Formulation of Beam Forming Problem>

Herein, signs and notation are defined and the problem is formulated. First, various definitions for mathematically describing the beam forming problem are determined.

Consideration is given to a situation in which a single target sound source and a plurality of interference sound sources are present in space, these mixed sounds are recorded with a microphone array including M nondirectional microphones, and a target sound coming from a specific direction is enhanced by causing observed M channel signals to pass through a beam forming filter. In order to introduce a model for describing this situation, variables are defined first. The following examination is performed basically in a short-time Fourier transform (STFT) domain.

It is assumed that a_{f}∈C^{H}(f=1, . . . , F) is a transfer function from the target sound source to the microphone array in a frequency bin f, a_{ikf}∈C^{M} is a transfer function from the k-th interference sound source to the microphone array in the frequency bin f, S_{f,t}∈C is a target sound signal in the frequency bin f in a time frame t(t=1, . . . , T), and n_{ikf,t}∈C^{M} is the k-th interference sound signal in the frequency bin f in the time frame t. By using these signs, based on an instantaneous mixture assumption, a signal z_{f,t} observed by the microphone array is expressed as

$$\begin{matrix}[ Math . 1 ] & \\ {z}_{f , t} = {s}_{f , t} {a}_{f} + {\sum }_{k} {n}_{ikf , t} {a}_{ikf} + {n}_{bf , t} . & ( 1 )\end{matrix}$$

Herein, n_{bf,t} represents a noise signal which is not assumed to derive from a specific interference sound source (e.g., a noise resulting from the performance of the microphone).

What we desire to determine is a linear filter which provides an estimated value y_{f,t} of the target sound signal s_{f,t} having high accuracy from the observed signal z_{f,t}. Hereinbelow, the filter coefficient of this linear filter is represented by w_{f}∈C^{M}. When the subscript t representing the time frame of the estimated value y_{f,t} is omitted and the estimated value is expressed as the estimated value y_{f}, a relationship among z_{f}, y_{f}, and w_{f} is given by

[Math. 2]

y_{f}=wⱼ^{H}z_{f} (2).

Herein, ^{H} denotes complex conjugate transpose.

Herein, a variable dependent on each of the filter coefficient and an observed sound is introduced. If the target sound can be extracted from the observed sound by using the filter, it follows that a non-target sound caused by the interference sound source can be estimated by subtracting the target sound from the observed sound. Accordingly, an estimated value e_{f}∈C^{M} of the non-target sound included in the observed sound is defined by

[Math. 3]

e_{f}=z_{f}−y_{f}h_{f}=z_{f}−(w_{f}^{H}z_{f})h_{f} (3).

Herein, h_{f}∈C^{H} is an array manifold vector of a target sound source direction. Normally, it is desirable to use the transfer function a_{f} instead of the array manifold vector h_{f} in a model in Expression (1), but it is practically difficult to precisely realize the transfer function constantly. To cope with this, in the definition of Expression (3), the array manifold vector h_{f} is used. Note that, when the beam former can extract the target sound properly, the estimated value e_{f} of the non-target sound is expected to be constituted mainly by the interference sound and background noises.

Herein, further, attention is focused on that the estimated value of each of the target sound and the non-target sound can be expressed as the affine transformation of the filter coefficient, and the estimated value thereof is expressed as a conversion equation which uses the filter coefficient.

Note that, hereinafter, for clarity of description, with regard to any variable x_{f} having a subscript related to the frequency bin f, information on all frequency bins is expressed as ^{˜}x=(x₁^{T}, . . . , x_{F}^{T})^{T}.

In addition, matrices Fₜ and Gₜ in the time frame t are defined by

[Math. 4]

Fₜ=diag[z_{1,t},z_{2,t}, . . . ,z_{F,t}]^{T}∈C^{F×MF} (4)

Gₜ=diag[h₁z_{1,t}^{T},h₂z_{2,t}^{T}, . . . ,h_{F}z_{F,t}^{T}]∈C^{MF×MF} (5).

Accordingly, each of an estimated value ^{˜}yₜ of the target sound (hereinafter referred to as an estimated target sound) serving as an output of the beam former in the time frame t and an estimated value ^{˜}eₜ of the noise (hereinafter referred to as an estimated noise or an estimated non-target sound) is expressed in the form of the following affine transformation of a filter coefficient ^{˜}w*:

[Math. 5]

[symbol]

=Fₜ\tilde{w}* (6)

[symbol]

=−Gₜ\tilde{w}*+ [symbol] (7)

(wherein * is complex conjugate).

<Conventional Beam Forming Optimization Problem>

First, the conventional beam forming optimization problem is described as the minimization problem of the cost function defined from the viewpoint of a probability model.

It is assumed that ^{˜}y, ^{˜}e, and ^{˜}w* are interpreted as random variables and their probability distributions P_{y}(^{˜}y), Pₑ(^{˜}e), and P_{w}(^{˜}w*) are already known. Among them, each of the probability distributions P_{y}(^{˜}y) and Pₑ(^{˜}e) is expected to have statistic properties of sound reflected therein. On the other hand, the probability distribution P_{w}(^{˜}w*) is often used to express assumptions of a frequency response to the target sound source direction. Based on these assumptions, the likelihood function of the random variable ^{˜}w* to a time series {^{˜}zₜ}ₜ₌₁ ^{T} of the observed sound is expressed as

$$\begin{matrix}[ Math . 6 ] & \\ L ( {\tilde{w}}^{*} ; \{ \} ) ∝ {\prod }_{t = 1}^{T} {P}_{y} ( ; {\tilde{w}}^{*} ) {P}_{e} ( ; {\tilde{w}}^{*} ) \cdot {P}_{w} ( {\tilde{w}}^{*} ) . & ( 8 )\end{matrix}$$

Note that ^{˜}yₜ and ^{˜}eₜ are determined by the affine transformations of ^{˜}w* expressed by Expression (6) and Expression (7). It is possible to derive a filter which is optimum in terms of a probability model by maximizing the likelihood with respect to ^{˜}w*. The likelihood maximization is equivalent to minimization of a negative logarithm likelihood, and hence a problem to be solved is a problem in the form of

$$\begin{matrix}[ Math . 7 ] & \\ {min}_{{\tilde{w}}^{*}} - log L ( {\tilde{w}}^{*} ; \{ . & ( 9 )\end{matrix}$$

Various conventional beam forming optimization problems can be interpreted as formulation based on Expression (9). Hereinbelow, as a specific example, the optimization problem of an MVDR beam former in NPL 1 will be described.

[Filter Design Phase: Cost Function of Filter Coefficient ^{˜}w*]

It is assumed that an estimated value R_{f}=E_{z_f}[z_{f}z_{f}^{H}] (f=1, . . . , F) of a spatial correlation matrix of an observed sound z_{f} in the frequency bin f is known, and the estimated non-target sound ^{˜}eₜ included in the observed sound conforms to normal distribution N (0, R_{f}) (i.e., e_{f,t}˜N(0, R_{f})).

At this point, a term ΠₜPₑ(^{˜}eₜ;^{˜}w*) for the non-target sound of the likelihood function is expressed as

$$\begin{matrix}[ Math . 8 ] & \\ {\prod }_{t = 1}^{T} {P}_{e} ( ; {\tilde{w}}^{*} ) ∝ {\prod }_{t = 1}^{T} {\prod }_{f = 1}^{F} exp ( - {e}_{f , t}^{H} {R}_{f}^{- 1} {e}_{f , t} ) & ( 10 ) \\ = exp ( - {\sum }_{t , f} {( {z}_{f , t} - ( {w}_{f}^{H} {z}_{f , t} ) {h}_{f} )}^{H} {R}_{f}^{- 1} ( {z}_{f , t} - ( {w}_{f}^{H} {z}_{f , t} ) {h}_{f} ) ) . & ( 11 )\end{matrix}$$

The assumption of the probability distribution is not set in other terms (ΠₜP_{y}(^{˜}yₜ;^{˜}w*) and P_{w}(^{˜}w*)).

[Filter Design Phase: Constraint Condition of Filter Coefficient ^{˜}w*]

A distortionless restraint w_{f}^{H}h_{f}=1 to the target sound source direction is imposed on each w_{f}* of the filter coefficient ^{˜}w*=(w₁^{*T}, . . . , w_{F}^{*T}).

[Filter Design Phase: Optimization Problem]

Based on these assumptions, by simple completing the square, the optimization problem based on Expression (9) in the frequency bin f can result in the form of

$$\begin{matrix}[ Math . 9 ] & \\ {min}_{{w}_{f}} {( {w}_{f } - {γ}_{f} {R}_{f}^{- 1} {h}_{f} )}^{H} {R}_{f} ( {w}_{f} - {γ}_{f} {R}_{f}^{- 1} {h}_{f} ) \\ s . t . {w}_{f}^{H} {h}_{f} = 1 & ( 12 )\end{matrix}$$

(wherein γ_{f}=(h_{f}^{H}R_{f}⁻¹hₜ)⁻¹ is satisfied).

[Filter Design Phase: Cost Function Optimization]

A solution to the problem of Expression (12) is a well-known MVDR beam former (i.e., γₜR_{f}⁻¹h_{f}).

Next, a description will be given of calculation (filter use phase) when the beam former is actually operated by using the filter coefficient obtained by the above-described procedures.

[Filter Use Phase: Filter Redesign]

In processing of beam forming, it is necessary to separate the observed sound on a per frame basis and perform the discrete Fourier transform on each frame and, in a situation in which beam forming is performed in real time, delay is increased when a frame length is long. To cope with this, a filter having low delay is redesigned. First, the inverse Fourier transform is performed on the filter coefficient ^{˜}w* designed in the filter design phase and the expression of the filter is returned to that in a time domain, whereby an impulse response wₘ[i] of each microphone m (m=1, . . . , M) is obtained. Based on a specified frame length Nₜₐₚ given as an input, only a vector w′ₘ₁[i] including the first Nₜₐₚ/2 component and a vector w′ₘ₂[i] including the last Nₜₐₚ/2 component are extracted from each impulse response wₘ[i] (i.e., the other elements are ignored), and a new impulse response in which the length is reduced to Nap expressed as

[Math. 10]

mₘ″[i]=[wₘ₂^{′T},wₘ₁^{′T}]^{T} (13)

is introduced. By performing the discrete Fourier transform on the impulse response w″ₘ[i] again, a filter coefficient ^{˜}w′* in which the number of elements is reduced (redesigned) to Nₜₐₚ is calculated.

[Filter Use Phase: Discrete Fourier Transform (DFT)]

Next, the observed sound serving as a beam forming processing target is separated in a time direction on a per Nₜₐₚ sample basis, the discrete Fourier transform is performed on each separated section (frame), and an observed sound ^{˜}z in an STFT domain is output.

[Filter Use Phase: Convolution]

Herein, convolution in Expression (2) is performed by using, as inputs, the observed sound ^{˜}z in the STFT domain and the filter coefficient ^{˜}w′*, and an estimated target sound ^{˜}y in the STFT domain is output.

[Filter Use Phase: Inverse Discrete Fourier Transform (inverse DFT)]

Lastly, the inverse discrete Fourier transform is performed on the estimated target sound ^{˜}y in the STFT domain, and a time-domain waveform subjected to the beam forming processing, i.e., the estimated target sound in the time series is obtained.

Expression (9) is formulation of the optimization problem of the variable ^{˜}w*, and the optimization problem can be easily solved in the case of a relatively simple example such as the above-described MVDR beam former. However, in the case where the cost function has a complicated expression, in general, it is difficult to similarly perform optimization. From this, it can be seen that the conventional method has two problems. As the first problem, the probability distribution assumed in the target sound ^{˜}y or the non-target sound ^{˜}e is often limited to a simple probability distribution such as the normal distribution in the conventional method, and the normal distribution is not necessarily appropriate as the description of a sound source distribution. As the second problem, the cost function which can be used as the constraint on the filter coefficient ^{˜}w* is also limited, and it is particularly difficult to reflect various probabilistic assumptions simultaneously. While the introduction of an additional constraint on the filter coefficient ^{˜}w* has been examined, minimization of the complicated cost function configured by reflecting various probabilistic assumptions simultaneously has been an extremely difficult problem in general. In particular, it has been difficult to configure the beam former capable of simultaneously achieving low delay, stability, and high noise suppression performance.

In order to solve the above problems, consideration is given to the case where the probabilistic assumption is set in the auxiliary variable such as the estimated target sound ^{˜}yₜ of Expression (6) or the estimated noise ^{˜}eₜ of Expression (7), and the cost function is expressed as the sum of cost terms related to individual auxiliary functions. Hereinbelow, a design method of the cost function based on this idea will be described.

<Optimization Problem Based on Cost Function in which Plurality of Characteristics are Reflected>

A new cost function for the beam forming optimization problem is expressed as the sum of terms of various convex functions. In addition, an argument in each term is assumed to be the auxiliary variable which can be defined as the affine transformation of the filter coefficient ^{˜}w* or the newly introduced filter coefficient ^{˜}w* (such as the estimated target sound ^{˜}yₜ or the estimated noise ^{˜}eₜ). With the cost function which meets these requests, it is easy to solve the optimization problem. In other words, it is possible to design the cost function freely within a range which meets these requests. Hereinafter, the detailed description thereof will be given.

[Filter Design Phase: Auxiliary Variable of Filter Coefficient ^{˜}w*]

J denotes any natural number, and an auxiliary variable vⱼ(j=1, . . . , J) is introduced. As the auxiliary variable vⱼ, a variable which satisfies a linear relation with the filter coefficient ^{˜}w*, i.e., a variable which satisfies a linear relational expression vⱼ=Dⱼ^{˜}w*+bⱼ is used. Each auxiliary variable vⱼ and the relational expression satisfied by the auxiliary variable vⱼ are generalization of Expression (6) and Expression (7) and, in this sense, the constraint in which the linear relational expression is satisfied includes the conventional method.

For the sake of simplicity, notation such as \hat{ }v=(v₁^{T}, . . . , v_{J}^{T}) T, \hat{ }D=(D₁^{T}, . . . , D_{J}^{T})^{T}, and \hat{ }b=(b₁^{T}, . . . , b_{J}^{T})^{T} is adopted in the following description.

[Filter Design Phase: Cost Term of Filter Coefficient ^{˜}w* Cost Term of Auxiliary Variable vⱼ]

By using a cost term L₀ of the filter coefficient ^{˜}w* and a cost term Lⱼ(j=1, . . . , J) of the auxiliary variable vⱼ, a cost function L is expressed in the form of

$$\begin{matrix}[ Math . 11 ] & \\ L ( {\tilde{w}}^{*} , \hat{v} ) = {L}_{0} ( {\tilde{w}}^{*} ) + {\sum }_{j = 1}^{J} {L}_{j} ( {v}_{j} ) & ( 14 )\end{matrix}$$

(wherein Lⱼ(j=0, . . . , J) is a convex function).

The sum of the convex function is the convex function, and hence the cost function L is also the convex function. The constraint in which the cost term of the auxiliary variable vⱼ is the convex function seems to be eccentric, but this denotes that log-concave probability distributions are used as the probability distributions of the auxiliary variables such as the estimated target sound ^{˜}yₜ of Expression (6) and the estimated noise ^{˜}eₜ of Expression (7). Herein, that the probability distribution is log-concave means that the negative logarithm of a probability density function (negative log) is the convex function. Many of probability distributions commonly used in the description of the probability model of the sound source such as the normal distribution and the Laplace distribution satisfy this property. The cost term Lⱼ in Expression (14) can be interpreted as the negative logarithm of the probability density function of the auxiliary variable vⱼ, and hence the convexity of the cost term is the property which is automatically satisfied as long as only the log-concave probability distribution is considered.

[Filter Design Phase: Optimization Problem]

From the examination described above, a problem which we should solve results in a typical convex optimization problem with a linear constraint which is expressed as

$$\begin{matrix}[ Math . 12 & \\ {min}_{\hat{v} , {\tilde{w}}^{*}} {L}_{0} ( {\tilde{w}}^{*} ) + {\sum }_{j = 1}^{J} {L}_{j} ( {v}_{j} ) s . t . \hat{v} = \hat{D} {\tilde{w}}^{*} + \hat{b} . & ( 15 )\end{matrix}$$

It is possible to solve the problem of Expression (15) by separating the terms into the term related to the filter coefficient and the term related to the auxiliary variable, and performing optimization on the terms alternately. As specific algorithms for solving the problem, various algorithms are known, and an example thereof includes an algorithm which adopts the alternating direction method of multipliers (ADMM) (this algorithm will be described later).

Subsequently, in order to demonstrate that it is possible to use various probabilistic assumptions as the probabilistic assumption imposed on the auxiliary variable in formulation of the problem of Expression (15), a description will be given of an example in which a filter which has low delay and is suitable for enhancement of voice while maintaining high noise suppression performance is designed.

<Specific Design Example of Beam Former in which Plurality of Characteristics are Reflected>

Herein, a practical situation is assumed as problem setting, and an example in which the cost function is specifically designed in the framework of Expression (15) is shown. Specifically, a situation in which, in an environment in which a plurality of interference sounds are emitted, voice emitted from a known position is streamed is assumed. Note that it is assumed that the interference sound source emits a noise conforming to complex normal distribution for each frequency bin. In the present situation, a beam former in which information that the target sound source is voice is reflected and which has low delay and is capable of maintaining high enhancement performance may be desired.

[Filter Design Phase: Cost Term of Filter Coefficient ^{˜}w*]

In the above situation, a constraint to be imposed on the filter coefficient ^{˜}w* is not present, and hence the cost term L₀ for the filter coefficient ^{˜}w* is not considered. That is, L₀(^{˜}w*)=0 is satisfied.

[Filter Design Phase: Auxiliary Variable of Filter Coefficient ^{˜}w*, Cost Term of Auxiliary Variable]

Subsequently, known information on the sound source and each of characteristics required of the beam former are examined, and the auxiliary variable and its cost term are designed.

First, consideration is given to the distribution of the target sound. In the above assumed situation, the information that the target sound is voice is known. It is known that voice has sparseness, and hence it is considered that the known information can be utilized by designing the cost term in which an assumption that the estimated target sound conforms to a sparse probability distribution is reflected. Accordingly, as the auxiliary variable, the estimated target sound ^{˜}yₜ is used. The definition of the auxiliary variable ^{˜}yₜ is identical to that in Expression (6). In addition, an assumption that the auxiliary variable ^{˜}yₜ conforms to the Laplace distribution of the following expression is used:

[Math. 13]

P(y_{f,t})∝ exp(−β|y_{f,t}) (16).

Herein, β(>0) is a constant parameter which determines the shape of the distribution. The Laplace distribution is often used in the expression of a sparse variable distribution, and is considered to be appropriate in the above assumed situation. Based on the assumption of Expression (16), a cost term L_{y} of the auxiliary variable ^{˜}y is in the form of

$$\begin{matrix}[ Math . 14 ] & \\ {L}_{y} ( \tilde{y} ) = {\sum }_{t = 1}^{T} {\sum }_{f = 1}^{F} β \vert {y}_{f , t} \vert & ( 17 )\end{matrix}$$

which expresses the negative logarithm of the Laplace distribution. The Laplace distribution is log-concave, and hence the cost term L_{y} is the convex function, and can be handled in the framework of Expression (15).

Next, some probability distribution is assumed for the non-target sound, and the introduction of the auxiliary variable and the cost term is similarly performed. As an estimated amount of the non-target sound included in the observed sound, the estimated non-target sound ^{˜}eₜ defined by Expression (7) is introduced as the auxiliary variable. In the assumed situation described above, it is assumed that the non-target sound mainly constituted by the interference sound conforms to the normal distribution. That is, the auxiliary variable ^{˜}eₜ is considered to be output according to a probability distribution expressed as

[Math. 15]

P(e_{f,t})∝ exp(−e_{f,t}^{H},R_{f}⁻¹e_{f,t}) (18).

Herein, R_{f} is a spatial correlation matrix related to the non-target sound, and can be estimated from observation data. An expression obtained by converting the assumption in Expression (18) into the form of the cost term of the auxiliary variable ^{˜}e is

$$\begin{matrix}[ Math . 16 ] & \\ {L}_{e} ( \tilde{e} ) = {\sum }_{t = 1}^{T} {\sum }_{f = 1}^{F} {e}_{f , t}^{H} {R}_{f}^{- 1} {e}_{f , t} . & ( 19 )\end{matrix}$$

The normal distribution is log-concave, and hence the cost term L_{c} is also the convex function.

Herein, we try to allow the beam former to have a low delay property by introducing an additional auxiliary variable and an additional cost term. For that purpose, we examine the cost term to be imposed on the filter coefficient ^{˜}w* which can implement a low-delay filter. In a conventional wide-band beam former, the filter coefficient is derived for each frequency bin individually, and a relationship between adjacent frequency bins is not taken into consideration. However, a frequency characteristic which is not continuous or smooth in a frequency bin direction leads to a long impulse response in a time domain. In addition, it is desirable to prevent group delay which causes phase lag. In order to obtain the filter coefficient which does not have such a characteristic as a solution, it is considered that it is effective to introduce a difference of the filter coefficient in the frequency bin direction as a new auxiliary variable and impose the cost term which reduces (the norm of) these auxiliary variables. Specifically, F−2 auxiliary variables at expressed as

[Math. 17]

η_{f}=w_{f}*−2w_{f+1}*+w_{f+2}* (f=1, . . . ,F−2) (20)

are newly defined. In Expression (20), η_{f} is intended to include information on second order differential with respect to a frequency direction of the amplitude and phase characteristic of the filter. By using Expression (20), a cost term L_{η_f}(η_{f}) of the auxiliary variable η_{f} is defined by

[Math. 18]

L_{η}_{_{f}}(η_{f})=λ∥η_{f}∥₂ (21).

[Filter Design Phase: Cost Function Optimization]

Thus, by using the assumption related to the auxiliary variable shown in each of Expression (18), Expression (16), and Expression (20), the cost function L is the sum of the individual cost terms as shown in the following expression:

$$\begin{matrix}[ Math . 19 ] & \\ L ( {\tilde{w}}^{*} , \hat{v} ) = {\sum }_{t = 1}^{T} {\sum }_{f = 1}^{F} ( {e}_{f , t}^{H} {R}_{f}^{- 1} {e}_{f , t} + β \vert {y}_{f , t} \vert ) + {\sum }_{f = 1}^{F - 2} λ {‖ {n}_{f} ‖}_{2} & ( 22 ) \\ \hat{v} = [ {e}_{1 , 1} , … , {e}_{F , T} , {y}_{1 , 1} … , {y}_{F , T} , {η}_{1} , … , {η}_{F - 2} ] . & ( 23 )\end{matrix}$$

All of 2FT+F−2 auxiliary variables appearing in the cost function L are expressed as the affine transformation of the filter coefficient ^{˜}w*, and hence the minimization problem of Expression (22) is a specific example of Expression (15).

While the optimization problem has been examined thus far with the beam forming used as its target, the mathematical framework described thus far has a more versatile application range, and is not limited to acoustic processing. In order to show the versatility of the present framework clearly, an example in which the above framework is applied to image processing will be described.

<One Example of Optimization Problem in Image Processing>

For example, consideration is given to a situation in which an image in which noise is superimposed on an image having a periodic pattern (hereinafter referred to as an original image) such as an image having a large number of objects having the same shape is given as an input, and an image obtained by removing the noise from the image is obtained. S=[S_{x,y}]_{1≤x≤X,1≤y≤Y} denotes a matrix representing values of individual pixels of the original image, and N denotes a matrix representing noises added to each pixel. It is assumed that the value of the noise is generated for each pixel individually according to normal distribution having the mean of 0 and the variance of 1. The image which we can observe is an image including the noise Y=S+N. At this point, in order to consider a problem of estimating the original image S from the image Y with high accuracy, the matrix S is considered to be ^{˜}w* in Expression (15), and the cost term related to the auxiliary variable determined by the matrix S or the affine transformation of the matrix S is configured.

[Filter Design Phase: Cost Term of Matrix S]

First, the image obtained as the result of estimation roughly coincides with the original image desirably, and hence, as the cost term related to the matrix S, a square error of individual pixels of the input image Y is imposed. When the cost term related to the matrix S is specifically written, the following expression is obtained:

$$\begin{matrix}[ Math . 20 ] & \\ {L}_{S} ( S ) = {\sum }_{x , y} {\vert {S}_{x , y} - {Y}_{x , y} \vert}^{2} . & ( 24 )\end{matrix}$$

A cost term L_{S} of Expression (24) is the convex function.

[Filter Design Phase: Auxiliary Variable⋅Cost Term of Auxiliary Variable]

Next, the auxiliary variable for removing the noise properly and its cost term are designed. We empirically know that the image is usually smooth and a fluctuation in value between adjacent pixels is small. The noises individually given to individual pixels display an unnatural behavior which runs contrary to the above property, and hence it is considered that the noises can be removed by designing the cost term which avoids the unnaturalness. Accordingly, amounts D₁ and D₂ defined as differences between adjacent pixels are introduced as the auxiliary variables given by the following expressions:

[Math. 21]

D_{1x,y}=S_{x+1,y}−S_{x,y} (1≤x≤X−1,1≤y≤Y) (25)

D_{2x,y}=S_{x+1,y}−S_{x,y} (1≤x≤X−1,1≤y≤Y) (26)

In the case of the image which is smooth and has higher naturalness, the absolute values of the auxiliary variables D₁ and D₂ should tend to be reduced. Accordingly, the following convex cost terms are imposed on the auxiliary variables D₁ and D₂:

$$\begin{matrix}[ Math . 22 ] & \\ {L}_{D 1} ( {D}_{1} ) = {\sum }_{x , y} \vert {D}_{1 x , y} \vert & ( 27 ) \\ {L}_{D 2} ( {D}_{2} ) = {\sum }_{x , y} \vert {D}_{2 x , y} \vert . & ( 28 )\end{matrix}$$

Each of these cost terms L_{D1} and L_{D2} is a cost term which implies noise removal.

Herein, further, a situation in which preliminary knowledge that the original image has a periodic structure is provided is assumed, and the auxiliary variable and the cost term capable of utilizing the preliminary knowledge are designed. In the periodic image, a spatial frequency spectrum obtained by performing the two-dimensional Fourier transform on the image is expected to have a sparse structure. The two-dimensional Fourier transform can be described as the affine transformation, and hence, by using the spatial frequency spectrum as the auxiliary variable and designing the cost term which makes the auxiliary variable sparse, it is considered that our objective is achieved. Specifically, the two-dimensional Fourier transform R=[R_{k,j}] of the image is introduced as the auxiliary variable. This can be defined by

$$\begin{matrix}[ Math . 23 ] & \\ {R}_{k , j} = {\sum }_{x , y} {W}_{k , j , x , y} {S}_{x , y} & ( 29 )\end{matrix}$$

by using a discrete Fourier transform matrix W_{k,j}, and is the affine transformation of the matrix S. As the cost term, the convex function in the form of

$$\begin{matrix}[ Math . 24 ] & \\ {L}_{R} ( R ) = {\sum }_{k , j} \vert {R}_{k , j} \vert & ( 30 )\end{matrix}$$

is assumed.

[Filter Design Phase: Cost Function Optimization]

With the design of the cost term described above, the cost function L to be optimized is expressed in the form of

[Math. 25]

L(S,D₁,D₂,R)=L_{S}(S)+L_{D1}(D₁)+L_{D2}(D₂)+L_{R}(R) (31).

Among variables in Expression (31), the matrix S is the variable serving as the estimation target, and the other variables are auxiliary variables of the matrix S.

From the examination described above, it can be seen that it is possible to design the cost function in the framework of Expression (15) also in the case of the image processing.

<Optimization Algorithm based on ADMM>

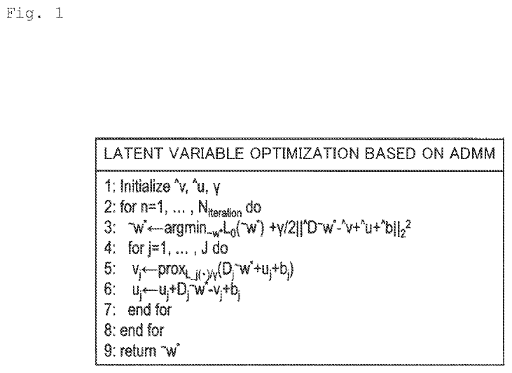

FIG. 1 is a view showing an iterative algorithm for actually solving the convex optimization problem with the linear restraint expressed by Expression (15). The algorithm is based on ADMM which is known as one of algorithms for efficiently solving the problem of Expression (15). The ADMM is an algorithm which performs optimization on a dual problem of an original problem, and uses a dual variable uⱼ having the same dimension as that of the auxiliary variable vⱼ.

Hereinbelow, a description will be given of an example in which the algorithm in FIG. 1 is applied to the cost function (22) which is configured by using the case of the beam former as an example. Herein, a specific iterative update expression is derived from an expression in FIG. 1.

First, with regard to an update rule of the variable ^{˜}w*, the cost term L₀ is not present in Expression (22), and hence an expression in Step 3 of FIG. 1 results in the form of

[Math. 26]

\tilde{w}*←(\hat{D}^{H}\hat{D})⁻¹\hat{D}^{H}(\hat{v}−û+\hat{b}) (32)

A matrix \hat{ }D^{H}\hat{ }D=ΣⱼDⱼ^{H}Dⱼ in the expression is a block banded matrix in the form of

$$\begin{matrix}[ Math . 27 ] & \\ {\hat{D}}^{H} \hat{D} = [ \begin{matrix}{A}_{1} + {I}_{M} & - 2 {I}_{M} & {I}_{M} & … & 0 \\ - 2 {I}_{M} & {A}_{3} + 5 {I}_{M} & - 4 {I}_{M} & … & 0 \\ {I}_{M} & - 4 {I}_{M} & {A}_{3} + 6 {I}_{M} & … & 0 \\ ⋮ & ⋮ & ⋮ & ⋱ & ⋮ \\ 0 & 0 & 0 & … & {A}_{F} + {I}_{M}\end{matrix} ] & ( 33 ) \\ {A}_{f} = ( 1 + {‖ {h}_{f} ‖}_{2}^{2} ) {\sum }_{t} {z}_{f , t}^{*} {z}_{f , t}^{T} , & ( 34 )\end{matrix}$$

and hence calculation of multiplication with (\hat{ }D^{H}\hat{ }D)⁻¹ which is required at the time of update is made efficient by performing the Cholesky decomposition of the matrix \hat{ }D^{H}\hat{ }D.

Subsequently, the update rule of the auxiliary variable is determined. The update rule is described as a proximity operator of each cost term. Herein, a proximity operator prox_{f} of a function f is defined in the form of prox_{f}(x)=argmin_{y}f(y)+∥x−y∥₂²/2. When this form is compared with the cost term, it can be seen that the update rule of each of an auxiliary variable y_{f,t} and an auxiliary variable η_{f} is expressed by the proximity operator of a 12 norm expressed as

$$\begin{matrix}[ Math . 28 ] & \\ {prox}_{λ {‖ \cdot ‖}_{2}} ( z ) = max ( {‖ z ‖}_{2} - λ , 0 ) \frac{z}{{‖ z ‖}_{2}} . & ( 35 )\end{matrix}$$

On the other hand, the cost term related to an auxiliary variable e_{f,t} is a simple quadratic form, and hence the update expression of e_{f,t} can be easily derived from the definition analytically. Eventually, the update rules of the auxiliary variables are expressed in the form of

$$\begin{matrix} [ Math . 29 ] & \\ {e}_{f , t} ← \frac{γ}{2} {{R}_{f} ( I + \frac{γ}{2} {R}_{f} )}^{- 1} ( {z}_{f , t} - ( {w}_{f}^{H} {z}_{f , t} ) {h}_{f} + {u}_{e , f , t} ) \\ {y}_{f , t} ← max ( 1 - \frac{β}{γ {‖ {w}_{f}^{H} {z}_{f , t} + {u}_{y , f , t} ‖}_{2}} , 0 ) ( {w}_{f}^{H} {z}_{f , t} + {u}_{y , f , t} ) \\ {η}_{f} ← max ( 1 - \frac{λ}{γ {‖ {w}_{f}^{*} - {ww}_{f + 1}^{*} + {w}_{f + 2}^{*} + {u}_{η , f} ‖}_{2}} , 0 ) ( {w}_{f}^{*} - {w}_{f + 1}^{*} + {w}_{f + 2}^{*} + {u}_{η , f} ) . & ( 36 )\end{matrix}$$

Herein, I denotes a unit matrix.

### Effect

In the principles of the embodiment of the present invention, the derivation of the filter coefficient of the beam former is interpreted as the cost function optimization problem, and the beam former having a plurality of desired characteristics is designed by imposing the constraints based on the individual cost terms on the filter coefficient and its auxiliary variable.

In the conventional method, it is not possible to perform design which uses a complicated cost function in which various factors such as the preliminary knowledge and desired characteristics are reflected. On the other hand, according to the principles of the embodiment of the present invention, the cost function is configured in the framework in which a plurality of new variables are introduced in the form of the auxiliary variables, and the cost terms are designed individually for the variables. Each cost term implies a probabilistic assumption and, in the case where particularly a log-concave probabilistic assumption is imposed, the problem to be solved results in the convex optimization problem with the linear constraint, and it is possible to solve the optimization problem relatively easily with various mathematical methods. With this, it becomes possible to perform filter design in which a plurality of assumptions are reflected simultaneously.

### First Embodiment

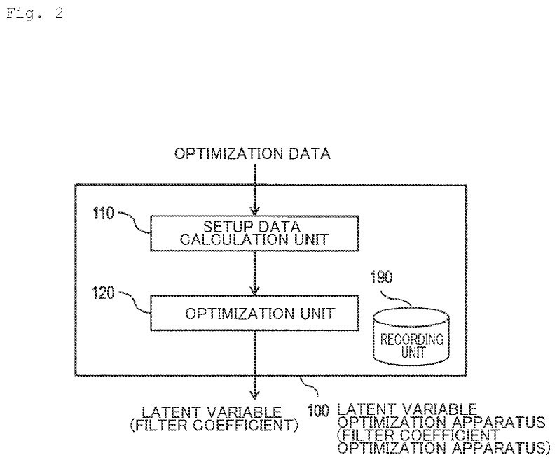

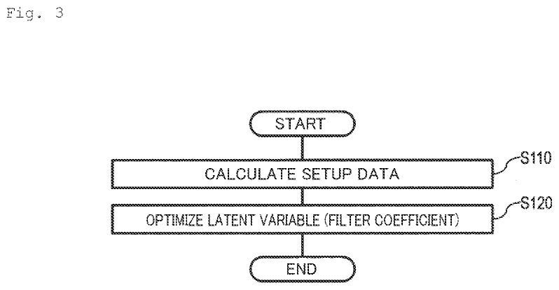

Hereinbelow, a latent variable optimization apparatus 100 will be described with reference to FIGS. 2 and 3. FIG. 2 is a block diagram showing the configuration of the latent variable optimization apparatus 100. FIG. 3 is a flowchart showing the operation of the latent variable optimization apparatus 100. As shown in FIG. 2, the latent variable optimization apparatus 100 includes a setup data calculation unit 110, an optimization unit 120, and a recording unit 190. The recording unit 190 is a constituent unit which appropriately records information required for processing of the latent variable optimization apparatus 100. The recording unit 190 records, e.g., a latent variable serving as an optimization target.

The latent variable optimization apparatus 100 optimizes a latent variable ^{˜}w* of a model serving as an optimization target by using optimization data. Herein, the model denotes a function which has input data as an input and has output data as an output (e.g., a filter of a beam former which has an observed sound as input data and has a target sound as output data), and the optimization data denotes input data used for optimization of the latent variable or a combination of input data used and output data for optimization of the latent variable.

According to FIG. 3, the operation of the latent variable optimization apparatus 100 will be described.

In S110, the setup data calculation unit 110 calculates setup data used when the latent variable ^{˜}w* is optimized by using the optimization data. For example, parameters included in Dⱼ(1≤j≤J), bⱼ(1≤j≤J) and a cost term L₁(0≤i≤J) used in a cost function L used to optimize the latent variable ^{˜}w*

$$\begin{matrix}[ Math . 30 ] & \\ L ( {\tilde{w}}^{*} , {v}_{1} , … , {v}_{J} ) = {L}_{0} ( {\tilde{w}}^{*} ) + {\sum }_{j = 1}^{J} {L}_{j} ( {v}_{j} ) & (* )\end{matrix}$$

(wherein vⱼ(1≤j≤J) is an auxiliary variable of the latent variable ^{˜}w* expressed as vⱼ=Dⱼ^{˜}w*+bⱼ by using a matrix Dⱼ and a vector bⱼ, L₀ is a cost term of the latent variable ^{˜}w*, and Lⱼ(1≤j≤J) is a cost term of the auxiliary variable vⱼ) are an example of the setup data. Note that the cost term L₁(0≤i≤J) is preferably a convex function.

For example, when it is assumed that the cost term of the auxiliary variable vⱼ(1≤j≤J) is expressed by using the probability distribution of the auxiliary variable vⱼ which is log-concave, the cost term L₁(1≤i≤J) is the convex function. In addition, for example, the cost term L₀ of the latent variable ^{˜}w* may satisfy L₀=0, and it is only required that the cost function L includes the sum of the cost term of the auxiliary variable vⱼ(1≤j≤J).

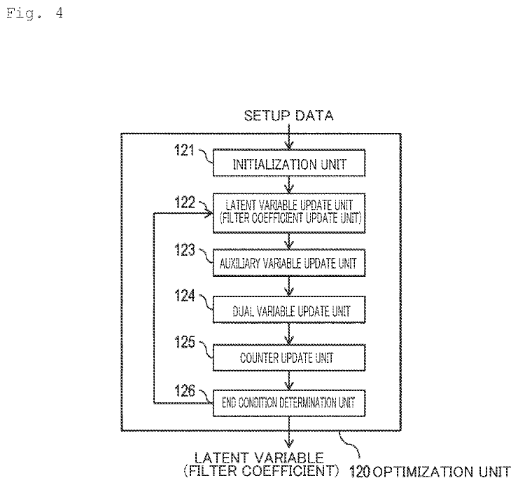

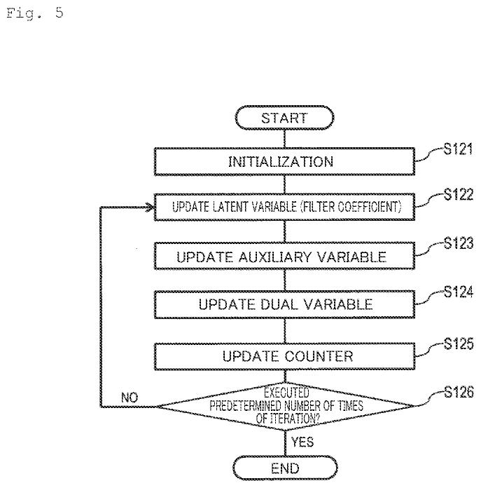

In S120, the optimization unit 120 optimizes the latent variable ^{˜}w* by solving the minimization problem of the cost function L. Hereinbelow, the optimization unit 120 will be described with reference to FIGS. 4 and 5. FIG. 4 is a block diagram showing the configuration of the optimization unit 120. FIG. 5 is a flowchart showing the operation of the optimization unit 120. As shown in FIG. 4, the optimization unit 120 includes an initialization unit 121, a latent variable update unit 122, an auxiliary variable update unit 123, a dual variable update unit 124, a counter update unit 125, and an end condition determination unit 126.

According to FIG. 5, the operation of the optimization unit 120 will be described.

In S121, the initialization unit 121 initializes a counter n. Specifically, the initialization unit 121 sets the counter n to n=1. In addition, the initialization unit 121 initializes an auxiliary variable \hat{ }v=(v₁^{T}, . . . , v_{J}^{T})^{T} and a dual variable \hat{ }u=(u₁^{r}, . . . , u_{J}^{T})^{T}. Further, the initialization unit 121 sets a constant serving as an initial value in γ.

In S122, the latent variable update unit 122 updates the latent variable ^{˜}w* by using the values of the auxiliary variable \hat{ }v and the dual variable \hat{ }u obtained at this point of time according to the following expression:

$$\begin{matrix}[ Math . 31 ] & \\ {\tilde{w}}^{*} ← arg {min}_{{\tilde{w}}^{*}} {L}_{0} ( {\tilde{w}}^{*} ) + \frac{γ}{2} {‖ \hat{D} {\tilde{w}}^{*} - \hat{v} + \hat{u} + \hat{b} ‖}_{2}^{2} . & \end{matrix}$$

Herein, \hat{ }D=(D₁^{T}, . . . , D_{J}^{T})^{T} and \hat{ }b=(b₁^{T}, . . . , b_{J}^{T})^{T} are satisfied.

In S123, the auxiliary variable update unit 123 updates the auxiliary variable vⱼ(1≤j≤J) by using the values of the latent variable ^{˜}w* and the dual variable uⱼ obtained at this point of time according to the following expression:

$$\begin{matrix}[ Math . 32 ] & \\ {v}_{j} ← arg {min}_{{v}_{j}} \frac{1}{γ} {L}_{j} ( {v}_{j} ) + \frac{1}{2} {‖ {D}_{j} {\tilde{w}}^{*} - {v}_{j} + {u}_{j} + {v}_{j} ‖}_{2}^{2} . & \end{matrix}$$

In S124, the dual variable update unit 124 updates the dual variable uⱼ(1≤j≤J) by using the values of the latent variable ^{˜}w*, the auxiliary variable vⱼ, and the dual variable uⱼ obtained at this point of time according to the following expression:

uⱼ←uⱼ+Dⱼ\tilde{w}*−vⱼ+bⱼ. [Math. 33]

In S125, the counter update unit 125 increments the counter n only by 1. Specifically, the counter update unit 125 sets the counter n to n←n+1.

In S126, in the case where the counter n has reached the predetermined number of times of update Nᵢₜₑᵣₐₜᵢₒₙ (Nᵢₜₑᵣₐₜᵢₒₙ is an integer of not less than 1 and is, e.g., 100,000) (i.e., in the case where n>Nᵢₜₑᵣₐₜᵢₒₙ is satisfied and an end condition is satisfied), the end condition determination unit 126 outputs the value ^{˜}w* of the latent variable at this point of time, and ends processing. Otherwise, the processing returns to the processing step in S122. That is, the optimization unit 120 repeats the processing steps in S122 to S126.

Note that, in the case where the cost function L which is defined by Expression (*) is used, it is possible to perform the optimization even when J is not less than 2.

In addition, as shown in Expression (*), when it is assumed that the cost term of the auxiliary variable vⱼ is expressed by using the probability distribution of the auxiliary variable vⱼ which is log-concave, it is only required that the cost function L includes the sum of the cost term of the auxiliary variable vⱼ. For example, when it is assumed that the cost term of the auxiliary variable vⱼ is expressed by using the probability distribution of the auxiliary variable vⱼ which is log-concave, the cost function L may be appropriately expressed as the sum of the cost term of the auxiliary variable vⱼ and the cost term which is determined based on the probability distribution which is log-concave.

According to the invention of the present embodiment, it becomes possible to optimize the latent variable by using the cost function based on the probabilistic assumptions on the latent variable and the auxiliary variable determined from the latent variable.

### Application Example

Herein, a description will be given of an example in which the latent variable optimization apparatus 100 is applied to the optimization of the filter coefficient of the beam former used for sound source enhancement. Accordingly, hereinbelow, the latent variable optimization apparatus 100 is referred to as a filter coefficient optimization apparatus 100. The optimization target of the filter coefficient optimization apparatus 100 is the filter coefficient of the beam former. The configuration of the filter coefficient optimization apparatus 100 is as shown in FIG. 2.

Hereinbelow, according to FIG. 3, the operation of the filter coefficient optimization apparatus 100 will be described.

In S110, the setup data calculation unit 110 calculates the setup data used when a filter coefficient ^{˜}w*=(w₁^{*T}, . . . , w_{F}^{*T}) (wherein w_{f}*(1≤f≤F) is a filter coefficient of a frequency bin f) is optimized. For example, a cost function L used to optimize the filter coefficient ^{˜}w* is expressed as the following expression:

$$\begin{matrix}[ Math . 34 ] & \\ L ( {\tilde{w}}^{*} , \hat{v} ) = {\sum }_{t = 1}^{T} {\sum }_{f = 1}^{F} ( {e}_{f , t}^{H} {R}_{f}^{- 1} {e}_{f , t} + β \vert {y}_{f , t} \vert ) + {\sum }_{f = 1}^{F - 2} λ {‖ {η}_{f} ‖}_{2} \\ \hat{v} = [ {e}_{1 , 1} , … , {e}_{F , T} , {y}_{1 , 1} … , {y}_{F , T} {η}_{1} , … , {η}_{F - 2} ] . & (* *)\end{matrix}$$

In the above expression, e_{f,t}(1≤f≤F,1≤t≤T) represents an auxiliary variable of the filter coefficient ^{˜}w* representing an estimated non-target sound of the frequency bin f in a time frame t. y_{f,t}(1≤f≤F,1≤t≤T) represents an auxiliary variable of the filter coefficient ^{˜}w* representing an estimated target sound of the frequency bin f in the time frame t. η^{f}(1≤f≤F−2) represents an auxiliary variable of the filter coefficient ^{˜}w* defined by η_{f}=w_{f}*−2w_{f+1}*+w_{f+2}*. R_{f}(1≤f≤F) represents a spatial correlation matrix related to a non-target sound of the frequency bin f. β(>0) represents a predetermined constant. λ represents a predetermined constant. Parameters included in three types of cost terms used in the above cost function L, i.e., L_{e,f,t}(e_{f,t})=e_{f,t}^{M}R_{f}⁻¹e_{f,t}(1≤f≤F,1≤t≤T), L_{y,f,t}(y_{f,t})=β|y_{f,t}|(1≤f≤F,1≤t≤T), and L_{η,f}(η_{f})=λ∥η_{f}∥₂(1≤f≤F−2) are an example of the setup data. Note that each of the cost terms L_{e,f,t}(e_{f,t}) (1≤f≤F,1≤t≤T), L_{y,f,t}(y_{f,t})(1≤f≤F,1≤t≤T), and L_{η,f}(η_{f})(1≤f≤F−2) is the convex function.

Note that the cost terms L_{e,f,t}(e_{f,t}), L_{y,f,t}(y_{f,t}), and L_{η,f}(η_{f}) are not limited to the cost terms described above, and the cost terms of the auxiliary variables e_{f,t}, y_{f,t}, and rat may be, e.g., any cost terms as long as the cost terms are expressed by using the probability distributions of the auxiliary variables e_{f,t}, y_{f,t}, and η_{f} which are log-concave.

Note that, in the above expression which defines the cost function L, the cost term L₀ of the filter coefficient ^{˜}w* satisfies L₀=0.

In S120, the optimization unit 120 optimizes the filter coefficient ^{˜}w* by solving the minimization problem of the cost function L. Hereinbelow, the optimization unit 120 will be described with reference to FIGS. 4 and 5. FIG. 4 is the block diagram showing the configuration of the optimization unit 120. FIG. 5 is the flowchart showing the operation of the optimization unit 120. Herein, the latent variable update unit 122 included in the optimization unit 120 is referred to as a filter coefficient update unit 122.

Hereinbelow, according to FIG. 5, the operation of the optimization unit 120 will be described.

In S121, the initialization unit 121 initializes the counter n. Specifically, the initialization unit 121 sets the counter n to n=1. In addition, the initialization unit 121 initializes an auxiliary variable \hat{ }v=[e_{1,1}, . . . , e_{F,T}, y_{1,1}, . . . , y_{F,T}, η₁, . . . , η_{F-2}], and a dual variable \hat{ }u=[u_{e,1,1}, . . . , u_{e,F,T}, u_{y,1,1}, . . . , u_{y,F,T}, u_{η,1}, . . . , u_{ηF-2}] (wherein u_{e,f,t}(1≤f≤F, 1≤t≤T) is a dual variable of the auxiliary variable e_{f,t}, u_{y,f,t}(1≤f≤F,1≤t≤T) is a dual variable of the auxiliary variable y_{f,t}, and u_{η,f}(1≤f≤F−2) is a dual variable of the auxiliary variable η_{f}). Further, the initialization unit 121 also sets a constant serving as an initial value in γ.

In S122, the filter coefficient update unit 122 updates the filter coefficient ^{˜}w* by using the values of the auxiliary variable \hat{ }v and the dual variable \hat{ }u obtained at this point of time according to the following expression:

\tilde{w}*←(\hat{D}^{H}\hat{D})⁻¹\hat{D}^{H}(\hat{v}−û−\hat{b}). [Math. 35]

Herein, \hat{ }D and \hat{ }b are given by the following expression:

$$\begin{matrix}\hat{D} = [ \begin{matrix}- {h}_{1} {z}_{1 , 1}^{T} & 0 & 0 & … & 0 \\ … & … & … & … & … \\ - {h}_{1} {z}_{1 , T}^{T} & 0 & 0 & … & 0 \\ 0 & - {h}_{1} {z}_{1 , 1}^{T} & 0 & … & 0 \\ … & … & … & … & … \\ 0 & 0 & 0 & … & - {h}_{1} {z}_{1 , T}^{T} \\ {z}_{1 , 1}^{T} & 0 & 0 & … & 0 \\ … & … & … & … & … \\ {z}_{1 , T}^{T} & 0 & 0 & … & 0 \\ 0 & {z}_{2 , 1}^{T} & 0 & … & 0 \\ … & … & … & … & … \\ 0 & 0 & 0 & … & {z}_{F , T}^{T} \\ 1 & - 2 & 1 & … & 0 \\ 0 & 1 & - 2 & … & 0 \\ … & … & … & … & … \\ 0 & 0 & 0 & … & 1\end{matrix} ] , \\ \hat{b} = {[ {z}_{1 , 1}^{T} , … , {z}_{1 , T}^{T} , {z}_{2 , 1}^{T} , … , {z}_{F , T}^{T} , 0 , … , 0 ]}^{T} .\end{matrix}$$

In S123, the auxiliary variable update unit 123 updates the auxiliary variable e_{f,t}(1≤f≤F,1≤t≤T), the auxiliary variable y_{f,t}(1≤f≤F,1≤t≤T), and the auxiliary variable η_{f}(1≤f≤F−2) by using the values of the latent variable ^{˜}w* and the dual variables u_{e,f,t}, u_{y,f,t}, and u_{η,t} obtained at this point of time according to the following expression:

$$\begin{matrix} [ Math . 37 ] & \\ {e}_{f , t} ← \frac{γ}{2} {{R}_{f} ( I + \frac{γ}{2} {R}_{f} )}^{- 1} ( {z}_{f , t} - ( {w}_{f}^{H} {z}_{f , t} ) {h}_{f} + {u}_{e , f , t} ) \\ {y}_{f , t} ← max ( 1 - \frac{β}{γ {‖ {w}_{f}^{H} {z}_{f , t} + {u}_{y , f , t} ‖}_{2}} , 0 ) ( {w}_{f}^{H} {z}_{f , t} + {u}_{y , f , t} ) \\ {η}_{f} ← max ( 1 - \frac{λ}{γ {‖ {w}_{f}^{*} - 2 {w}_{f + 1}^{*} + {w}_{f + 2}^{*} + {u}_{η , f} ‖}_{2}} , 0 ) ( {w}_{f}^{*} - {w}_{f + 1}^{*} + {w}_{f + 2}^{*} + {u}_{η , f} ) & \end{matrix}$$

(wherein z_{f,t}(1≤f≤F,1≤t≤T) represents an observed sound of the frequency bin f in the time frame t, and h_{f}(1≤f≤F) represents an array manifold vector of a beam direction in the frequency bin f).

In S124, the dual variable update unit 124 updates the dual variables u_{e,f,t}, u_{y,f,t}, and u_{η,f} by using the values of the latent variable ^{˜}w* and the auxiliary variables e_{f,t}, y_{f,t}, and η_{f} obtained at this point of time according to the following expression:

u_{e,f,t}←u_{e,f,t}+(z_{f,t}−h_{f}(w_{f}^{H}z_{f,t}))−e_{f,t}

u_{y,f,t}←u_{y,f,t}+w_{f}^{H}z_{f,t}−y_{f,t},

u_{η,f}←u_{η,f}+(w_{f+2}*−2w_{f+1}*+w_{f}*)−η_{f}. [Math. 38]

In S125, the counter update unit 125 increments the counter n only by 1. Specifically, the counter update unit 125 sets the counter n to n−n+1.

In S126, in the case where the counter n has reached the predetermined number of times of update Nᵢₜₑᵣₐₜᵢₒₙ (Nᵢₜₑᵣₐₜᵢₒₙ is an integer of not less than 1 and is, e.g., 100,000) (i.e., in the case where n>Nᵢₜₑᵣₐₜᵢₒₙ is satisfied and the end condition is satisfied), the end condition determination unit 126 outputs the value ^{˜}w* of the filter coefficient at this point of time, and ends the processing. Otherwise, the processing returns to the processing step in S122. That is, the optimization unit 120 repeats the processing steps in S122 to S126.

Note that, as shown in Expression (**), when it is assumed that the cost terms of the auxiliary variables e_{f,t}, y_{f,t}, and η_{f} are expressed by using the probability distributions of the auxiliary variables e_{f,t}, y_{f,t}, and η_{f} which are log-concave, it is only required that the cost function L includes the sum of the cost terms of the auxiliary variables e_{f,t}, y_{f,t}, and η_{f}. For example, when it is assumed that the cost terms of the auxiliary variables e_{f,t}, y_{f,t}, and η_{f} are expressed by using the probability distributions of the auxiliary variables e_{f,t}, y_{f,t}, and η_{f} which are log-concave, the cost function L may be appropriately expressed as the sum of the cost terms of the auxiliary variables e_{f,t}, y_{f,t}, and η_{f} and the cost terms determined based on the probability distributions which are log-concave.

### APPENDIX

An apparatus of the present invention includes, as, e.g., a single hardware entity, an input unit to which a keyboard or the like can be connected, an output unit to which a liquid crystal display or the like can be connected, a communication unit to which a communication apparatus (e.g., a communication cable) which allows communication with the outside of the hardware entity can be connected, a CPU (Central Processing Unit, may include a cache memory and a register), a RAM or ROM serving as a memory, an external storage apparatus which is a hard disk, and a bus which connects the input unit, the output unit, the communication unit, the CPU, the RAM, the ROM, and the external storage apparatus so as to allow exchange of data among the input unit, the output unit, the communication unit, the CPU, the RAM, the ROM, and the external storage apparatus. In addition, on an as needed basis, an apparatus (drive) capable of read and write of a recording medium such as a CD-ROM may be provided in the hardware entity. An example of a physical entity including such hardware resources includes a general-purpose computer.

In the external storage apparatus of the hardware entity, a program required to implement the above-described function and data required in processing of the program are stored (the storage of the program is not limited to the external storage apparatus and the program may also be stored in, e.g., a ROM which is a read-only storage apparatus). In addition, data obtained by the processing of the program is appropriately stored in the RAM or the external storage apparatus.

In the hardware entity, each program stored in the external storage apparatus (or the ROM) and data required for the processing of each program are read into the memory on an as needed basis, and are appropriately interpreted, executed, and processed in the CPU. As a result, the CPU implements predetermined function (individual constituent requirements expressed as the units and the means described above).

The present invention is not limited to the above-described embodiment, and can be appropriately changed without departing from the gist of the present invention. In addition, the processing steps described in the above embodiment may be executed not only chronologically according to the order of the description but also in parallel or individually according to the processing ability of an apparatus which executes the processing steps or on an as needed basis.

As described above, in the case where the processing function in the hardware entity (the apparatus of the present invention) described in the above embodiment is implemented by a computer, the processing contents of the function which the hardware entity should have are described by a program. By executing the program with the computer, the processing function in the above hardware entity is implemented on the computer.

The program in which the processing contents are described can be recorded in a computer-readable recording medium. The computer-readable recording medium may be any medium such as, e.g., a magnetic recording apparatus, an optical disk, a magneto-optical recording medium, or a semiconductor memory. Specifically, for example, it is possible to use a hard disk apparatus, a flexible disk, or a magnetic tape as the magnetic recording apparatus, a DVD (Digital Versatile Disc), a DVD-RAM (Random Access Memory), a CD-ROM (Compact Disc Read Only Memory), or a CD-R (Recordable)/RW (ReWritable) as the optical disc, an MO (Magneto-optical disk) as the magneto-optical recording medium, and an EEP-ROM (Electrically Erasable and Programmable-Read Only Memory) as the semiconductor memory.

Distribution of the program is performed by selling, transferring, or lending a portable recording medium such as a DVD or a CD-ROM in which the program is recorded. Further, the program may be stored in a storage apparatus of a server computer in advance, and the program may be distributed by transferring the program from the server computer to another computer via a network.

First, for example, the computer which executes such a program temporarily stores the program recorded in the portable recording medium or the program transferred from the server computer in a storage apparatus of the computer. Subsequently, when processing is executed, the computer reads the program stored in its storage apparatus, and executes the processing corresponding to the read program. As another execution mode of the program, the computer may read the program directly from the portable recording medium and execute the processing corresponding to the program. Further, every time the program is transferred to the computer from the server computer, the computer may execute the processing corresponding to the received program. A configuration may also be adopted in which the above processing is executed by what is called an ASP (Application Service Provider)-type service in which the transfer of the program to the computer from the server computer is not performed and the processing function is implemented only by execution instructions and result acquisition. Note that the program in the present mode includes information which is used for processing by an electronic calculator and is equivalent to the program (data which is not a direct command to the computer but has a property specifying the processing of the computer, and the like).

In addition, in this mode, while the hardware entity is configured by executing the predetermined program on the computer, at least part of the processing contents may also be implemented by hardware.

The description of the embodiment of the present invention described above is presented for the purpose of illustration and description. The description thereof is not intended to be exhaustive, and is not intended to limit the invention to the disclosed strict form. Modifications and variations are possible in light of the above teaching. The embodiment has been chosen and described to provide the best illustration of the principles of the invention, and to enable persons skilled in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A latent variable optimization apparatus comprising:
an optimizer configured to optimize a latent variable ^{˜}w*, wherein vⱼ(1≤j≤J) is an auxiliary variable of the latent variable ^{˜}w* expressed as vⱼ=Dⱼ^{˜}w*+bⱼ by using a matrix Dⱼ and a vector bⱼ, a cost term of the auxiliary variable vⱼ is expressed by using a probability distribution of the auxiliary variable vⱼ which is log-concave, and the optimizer optimizes the latent variable ^{˜}w* by solving a minimization problem of a cost function including the sum of the cost term of the auxiliary variable vⱼ.

2. The latent variable optimization apparatus according to claim 1, wherein the cost function is defined by
$$\begin{matrix}[ Math . 39 ] & \\ L ( {\tilde{w}}^{*} , {v}_{1} , … , {v}_{J} ) = {L}_{0} ( {\tilde{w}}^{*} ) + {\sum }_{j = 1}^{J} {L}_{j} ( {v}_{j} ) & \end{matrix}$$
(wherein L₀ is a cost term of the latent variable ^{˜}w*, and Lⱼ(1≤j≤J) is a cost term of the auxiliary variable vⱼ).

3. The latent variable optimization apparatus according to claim 2, wherein uⱼ(1≤j≤J) is a dual variable of the auxiliary variable vⱼ, \hat{ }v=(v₁^{T}, . . . , vⱼ^{T})^{T}, \hat{ }D=(D₁^{T}, . . . , D_{J}^{T})^{T}, \hat{ }b=(b₁^{T}, . . . , bⱼ^{T})^{T}, \hat{ }u=(u₁^{T}, . . . ,uⱼ^{T})^{T}), and γ are predetermined constants, and the optimizer includes: a latent variable updater configured to update the latent variable ^{˜}w* according to the following expression:
$$\begin{matrix}[ Math . 40 ] & \\ {\tilde{w}}^{*} ← arg {min}_{{\tilde{w}}^{*}} {L}_{0} ( {\tilde{w}}^{*} ) + \frac{γ}{2} {‖ \hat{D} {\tilde{w}}^{*} - \hat{v} + \hat{u} + \hat{b} ‖}_{2}^{2} ; & \end{matrix}$$
an auxiliary variable updater configured to update the auxiliary variable vⱼ(1≤j≤J) according to the following expression:
$$\begin{matrix}[ Math . 41 ] & \\ {v}_{j} ← arg {min}_{{v}_{j}} \frac{1}{γ} {L}_{j} ( {v}_{j} ) + \frac{1}{2} {‖ {D}_{j} {\tilde{w}}^{*} - {v}_{j} + {u}_{j} + {v}_{j} ‖}_{2}^{2} ; & \end{matrix}$$
and
a dual variable updater configured to update the dual variable uⱼ(1≤j≤J) according to the following expression:
uⱼ←uⱼ+Dⱼ\tilde{w}*−vⱼ+bⱼ. [Math. 42]

4. A filter coefficient optimization apparatus comprising:
an optimizer configured to update a filter coefficient ^{˜}w*=(w₁^{*T}, . . . , w_{F}^{*T}) (wherein w_{f}*(1≤f≤F) is a filter coefficient of a frequency bin t) of a beam former, wherein e_{f,t}(1≤f≤F,1≤t≤T) is an auxiliary variable of the filter coefficient ^{˜}w* representing an estimated non-target sound of the frequency bin fin a time frame t, y_{f,t}(1≤f≤F,1≤t≤T) is an auxiliary variable of the filter coefficient ^{˜}w* representing an estimated target sound of the frequency bin f in the time frame t, η_{f}(1≤f≤F−2) is an auxiliary variable of the filter coefficient ^{˜}w* defined by η_{f}=w_{f}*−2w_{f+1}*+w_{f+2}*, cost terms of the auxiliary variables e_{f,t}, y_{f,t}, and η_{f} are expressed by using probability distributions of the auxiliary variables e_{f,t}, y_{f,t}, and η_{f} which are log-concave, and the optimizer optimizes the filter coefficient ^{˜}w* by solving a minimization problem of a cost function including the sum of the cost terms of the auxiliary variables e_{f,t}, y_{f,t}, and η_{f}.

5. The filter coefficient optimization apparatus according to claim 4, wherein the cost function is defined by
$$\begin{matrix}[ Math . 43 ] \\ L ( {\tilde{w}}^{*} , \hat{v} ) = {\sum }_{t = 1}^{T} {\sum }_{f = 1}^{F} ( {e}_{f , t}^{H} {R}_{f}^{- 1} {e}_{f , t} + β \vert {y}_{f , t} \vert ) + {\sum }_{f = 1}^{F - 2} λ {‖ {η}_{f} ‖}_{2} \\ \hat{v} = [ {e}_{1 , 1} , … , {e}_{F , T} , {y}_{1 , 1} … , {y}_{F , T} {η}_{1} , … , {η}_{F - 2} ]\end{matrix}$$
(wherein R_{f}(1≤f≤F) is a spatial correlation matrix related to a non-target sound of the frequency bin f, β(>0) is a predetermined constant, and λ is a predetermined constant).

6. The filter coefficient optimization apparatus according to claim 5, wherein u_{e,f,t}(1≤f≤F,1≤t≤T) is a dual variable of the auxiliary variable e_{f,t}, u_{y,f,t}(1≤f≤F,1≤t≤T) is a dual variable of the auxiliary variable y_{f,t}, u_{η,f}(1≤f≤F−2) is a dual variable of the auxiliary variable η_{f}, \hat{ }u=[u_{e,1,1}, . . . , u_{e,F,T,}u_{y,1,1}, . . . , u_{y,F,T},u_{η,1}, . . . , u_{η,F-2}] and γ are predetermined constant, and the optimizer includes: a filter coefficient updater configured to update the filter coefficient ^{˜}w* according to the following expression:
\tilde{w}*←(\hat{D}^{H}\hat{D})⁻¹\hat{D}^{H}(\hat{v}−û−\hat{b}) [Math. 44]
(wherein \hat{ }D and \hat{ }b are given by the following expression:
$$\begin{matrix}[ Math . 45 ] & \\ \begin{matrix}\hat{D} = [ \begin{matrix}- {h}_{1} {z}_{1 , 1}^{T} & 0 & 0 & … & 0 \\ … & … & … & … & … \\ - {h}_{1} {z}_{1 , T}^{T} & 0 & 0 & … & 0 \\ 0 & - {h}_{1} {z}_{1 , 1}^{T} & 0 & … & 0 \\ … & … & … & … & … \\ 0 & 0 & 0 & … & - {h}_{1} {z}_{1 , T}^{T} \\ {z}_{1 , 1}^{T} & 0 & 0 & … & 0 \\ … & … & … & … & … \\ {z}_{1 , T}^{T} & 0 & 0 & … & 0 \\ 0 & {z}_{2 , 1}^{T} & 0 & … & 0 \\ … & … & … & … & … \\ 0 & 0 & 0 & … & {z}_{F , T}^{T} \\ 1 & - 2 & 1 & … & 0 \\ 0 & 1 & - 2 & … & 0 \\ … & … & … & … & … \\ 0 & 0 & 0 & … & 1\end{matrix} ] , \\ \hat{b} = {[ {z}_{1 , 1}^{T} , … , {z}_{1 , T}^{T} , {z}_{2 , 1}^{T} , … , {z}_{F , T}^{T} , 0 , … , 0 ]}^{T} ,\end{matrix} & \end{matrix}$$
z_{f,t}(1≤f≤F,1≤t≤T) is an observed sound of the frequency bin f in the time frame t, and h_{f}(1≤f≤F) is an array manifold vector of a beam direction in the frequency bin f);
an auxiliary variable updater configured to update the auxiliary variable e_{f,t}(1≤f≤F,1≤t≤T), the auxiliary variable y_{f,t}(1≤f≤F,1≤t≤T), and the auxiliary variable η_{f}(1≤f≤F−2) according to the following expression:
$$\begin{matrix} [ Math . 46 ] & \\ {e}_{f , t} ← \frac{γ}{2} {{R}_{f} ( I + \frac{γ}{2} {R}_{f} )}^{- 1} ( {z}_{f , t} - ( {w}_{f}^{H} {z}_{f , t} ) {h}_{f} + {u}_{e , f , t} ) \\ {y}_{f , t} ← max ( 1 - \frac{β}{γ {‖ {w}_{f}^{H} {z}_{f , t} + {u}_{y , f , t} ‖}_{2}} , 0 ) ( {w}_{f}^{H} {z}_{f , t} + {u}_{y , f , t} ) \\ {η}_{f} ← max ( 1 - \frac{λ}{γ {‖ {w}_{f}^{*} - {w}_{f + 1}^{*} + {w}_{f + 2}^{*} + {u}_{η , f} ‖}_{2}} , 0 ) ( {w}_{f}^{*} - {w}_{f + 1}^{*} + {w}_{f + 2}^{*} + {u}_{η , f} ) ; & \end{matrix}$$
and
a dual variable updater configured to update the dual variable u_{e,f,t}(1≤f≤F,1≤t≤T), the dual variable u_{y,f,t}(1≤f≤F,1≤t≤T), and the dual variable u_{η,f}(1≤f≤F−2) according to the following expression:
u_{e,f,t}←u_{e,f,t}+(z_{f,t}−h_{f}(w_{f}^{H}z_{f,t}))−e_{f,t}
u_{y,f,t}←u_{y,f,t}+w_{f}^{H}z_{f,t}−y_{f,t}
u_{η,f}←u_{η,f}+(w_{f+2}*−2w_{f+1}+w_{f}*). [Math. 47]

7. (canceled)

8. A latent variable optimization method in which a latent variable optimization apparatus executes an optimization step of optimizing a latent variable ^{˜}w*, wherein vⱼ(1≤j≤J) is an auxiliary variable of the latent variable ^{˜}w* expressed as vⱼ=Dⱼ^{˜}w*+bⱼ by using a matrix Dⱼ and a vector bⱼ, a cost term of the auxiliary variable vⱼ is expressed by using a probability distribution of the auxiliary variable vⱼ which is log-concave, and the optimization step optimizes the latent variable ^{˜}w* by solving a minimization problem of a cost function including the sum of the cost term of the auxiliary variable vⱼ.

9. The latent variable optimization method according to claim 8, wherein the cost function is defined by
$$\begin{matrix}[ Math . 48 ] & \\ L ( {\tilde{w}}^{*} , {v}_{1} , … , {v}_{J} ) = {L}_{0} ( {\tilde{w}}^{*} ) + {\sum }_{j = 1}^{J} {L}_{j} ( {v}_{j} ) & \end{matrix}$$
(wherein L₀ is a cost term of the latent variable ^{˜}w*, and Lⱼ(1≤j≤J) is a cost term of the auxiliary variable vⱼ).

10.-13. (canceled)
